(19) United States
(12) Patent Application Publication
(10) Pub. No.: US 2012/0270691 A1
(43) Pub. Date: Oct. 25, 2012

(54) MULTI-MODE ELECTRIC DRIVE HYBRID TRANSMISSION

(75) Inventors: Christopher A. Tuckfield, Beverly Hills, MI (US); Benjamin Kaehler, Stuttgart (DE); Klaus Kersting, Sitges (Barcelona) (ES); Markus Brouwer, Stuttgart (DE)

(73) Assignee: CHRYSLER GROUP LLC, Auburn Hills, MI (US)

(21) Appl. No.: 13/428,587

(22) Filed: Mar. 23, 2012

Related U.S. Application Data
(60) Provisional application No. 61/466,607, filed on Mar. 23, 2011.

(51) Int. Cl. F16H 37/06

(52) U.S. Cl. 475/5; 74/661

(57) ABSTRACT

A hybrid powertrain for a vehicle having a disconnect clutch located between an internal combustion engine, or other power source, and a hybrid transmission. When deactivated, the disconnect clutch decouples the engine from the hybrid transmission, which enables the hybrid transmission input shaft to rotate independently of the internal combustion engine. This enables enhanced electric drive performance for the hybrid transmission. The disconnect clutch provides for internal combustion engine starting, including internal combustion starting at high vehicle speeds.

### CROSS-REFERENCE TO RELATED APPLICATION

This application claims the benefit of U.S. Provisional Ser. No. 61/466,607, filed Mar. 23, 2011.

### FIELD

The present disclosure relates to a device for enabling electric drive of a hybrid transmission, and more particularly to a device for enabling electric drive of a hybrid transmission where the hybrid transmission is selectively disconnected from an internal combustion engine.

### BACKGROUND

Many current hybrid powertrains feature an uninterruptable coupling between a hybrid transmission and an internal combustion engine. Such hybrid powertrains provide for vehicle operation while the internal combustion engine is completely turned off. In a typical two electric motor hybrid powertrain that is to be operated in a purely electric mode, a first electric motor provides the torque necessary to propel the vehicle. At the same time, a second electric motor is powered to rotate (freewheel) at the exact speed necessary such that a transmission input shaft, coupled to the vehicle's internal combustion engine, does not rotate. The second electric motor must freewheel at speeds proportional to the speed of the vehicle. Freewheeling of the second electric motor produces disadvantageous system losses within the hybrid powertrain and reduces the efficiency of the vehicle. In addition, at high vehicle speeds, the second electric motor must freewheel at high RPM and, accordingly, limits the top speed and electric range of the vehicle when operating in a purely electric mode.

Many two electric motor hybrid transmissions provide for operation where the engine provides propulsive force and the two electric motors are powered in different manners in order to electrically vary the overall gear ratio of the hybrid transmission. When changing between operating modes in a typical hybrid powertrain, operational considerations sometimes require that the transmission pass through a fixed gear operation state when passing from one electrically variable mode to another electrically variable mode. As a result, the internal combustion engine is be briefly rotated at higher speeds during the gear change. This increases system losses and presents noise and vibration problems. Also, the internal combustion engine in a typical hybrid powertrain frequently is subjected to a large burst of high RPM operation (flare) when started during high speed electric operation of the vehicle, causing unnecessary wear on the engine as well as noise, vibration, and other discomfort to vehicle occupants. In addition, a typical hybrid powertrain can only use one of the two motors to drive with the engine off and can provide only a limited amount of torque in reverse gear operation.

### SUMMARY

In one form, the present disclosure provides a hybrid powertrain having an input shaft, a disconnect clutch coupled to the input shaft, and a transmission input shaft coupled to the disconnect clutch. The hybrid powertrain further includes a first plurality of gears and shafts coupled to the transmission input shaft, a first electric motor coupled to the first plurality of gears and shafts, a second electric motor coupled to the first plurality of gears and shafts; and an output shaft coupled to the first plurality of gears and shafts.

In another form, the present disclosure provides a powertrain having an input shaft, a disconnect clutch coupled to the input shaft, a transmission input shaft coupled to the disconnect clutch and an output shaft coupled to the transmission input shaft through at least a first gear set. The powertrain further includes a first electric motor coupled to the first gear set, and a second electric motor coupled to the first gear set.

Further areas of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a schematic representation of a prior art hybrid powertrain;

FIG. 2 is a lever diagram of the prior art hybrid powertrain of FIG. 1;

FIG. 3 is a table showing operating modes of the prior art hybrid powertrain of FIG. 1;

FIG. 4 is a schematic representation of an exemplary hybrid powertrain according to the principles of the present disclosure;

FIG. 5 is an exemplary lever diagram of the hybrid powertrain of FIG. 4;

FIG. 6 is a table showing exemplary operating modes of the hybrid powertrain of FIG. 4;

FIG. 7 is a table showing operating modes of another hybrid powertrain fitted with a disconnect clutch;

FIG. 8 is a table showing operating modes of another prior art powertrain;

FIG. 9 is a table showing operating modes of the hybrid powertrain of FIG. 8 fitted with a disconnect clutch;

FIG. 10 is a table showing operating modes of another prior art powertrain; and

FIG. 11 is a table showing operating modes of the hybrid powertrain of FIG. 10 fitted with a disconnect clutch.

### DETAILED DESCRIPTION

Before describing the disclosed embodiments of the technology in detail, it is to be understood that the technology is not limited in its application to the details of the particular arrangement shown here since the technology is capable of other embodiments. Also, the terminology used herein is for the purpose of description and not of limitation. Thus, it should be understood that the disclosed disconnect clutch may be implemented in any two motor hybrid powertrain. Where the motors can be electric, hydraulic, pneumatic or any other type that can produce and absorb mechanical power and convert it to a second type of power. The disclosed disconnect clutch may be implemented with a hybrid powertrain having a plurality of gears and shafts, planetary gears, Ravigneaux gears, or any other type of internal gearing arrangement.

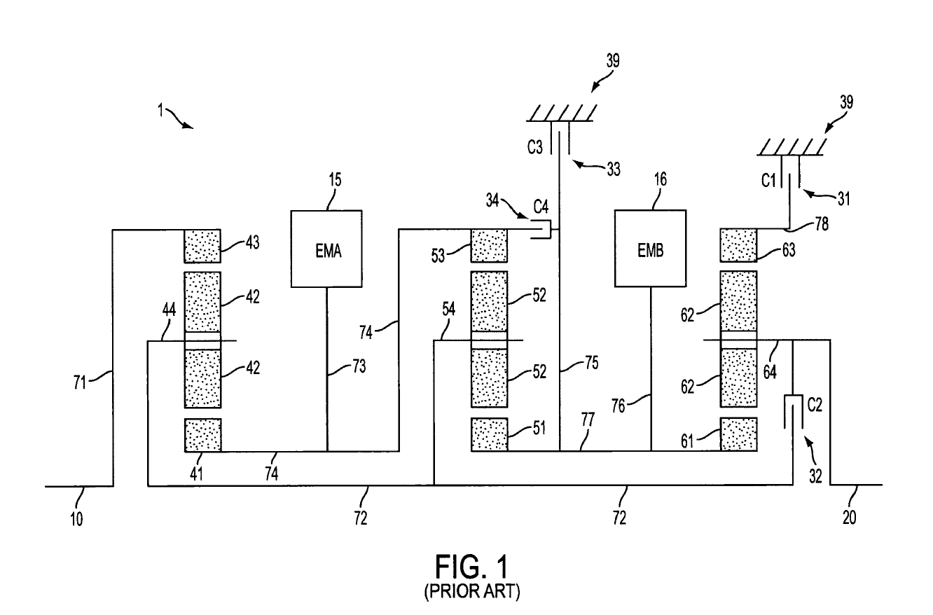

FIG. 1 is a schematic representation of a typical prior art hybrid powertrain 1. The hybrid powertrain 1 includes an input shaft 10 coupled to an input ring gear 43 by a shaft 71. The input ring gear 43 is continuously meshed with a plurality of input pinion gears 42 that are in turn meshed with an input sun gear 41. The input sun gear 41 is coupled by a shaft 74 to ring gear 53. The shaft 74 is coupled by another shaft 73 to a first electric motor 15 (“EMA”). An input carrier 44, upon which the input pinion gears 42 are rotatably mounted, is coupled to a shaft 72.

The ring gear 53 is continuously meshed with a plurality of pinion gears 52 that are in turn meshed with a sun gear 51. The sun gear 51 is coupled by a shaft 77 to an output sun gear 61. The powertrain 1 includes four clutch mechanisms 31 (C1), 32 (C2), 33 (C3), 34 (C4). A shaft 75 couples shaft 77 to the third clutch mechanism 33. The third clutch mechanism 33 selectively couples shaft 75 and, thereby, shaft 77 to the transmission housing 39. A shaft 76 couples shaft 77 to a second electric motor 16 (“EMB”). The ring gear 53 and, thereby, shaft 74, is selectively coupled to shaft 75 by the fourth clutch mechanism 34. A carrier 54, upon which pinion gears 52 are rotatably mounted, is coupled to a shaft 72.

The output sun gear 61 is continuously meshed with a plurality of output pinion gears 62 that are in turn meshed with an output ring gear 63. The output ring gear 63 is coupled by a shaft 78 to the first clutch mechanism 31. The first clutch mechanism 31 selectively couples shaft 78 and, thereby, output ring gear 63 to the transmission housing 39. An output carrier 64, upon which the output pinion gears 62 are rotatably mounted, is coupled to an output shaft 20. The output carrier 64 is also coupled to the second clutch mechanism 32. The shaft 72 and, thereby, input carrier 44 and carrier 54 are coupled to the second clutch mechanism 32. The second clutch mechanism 32 selectively couples shaft 72 to output carrier 64.

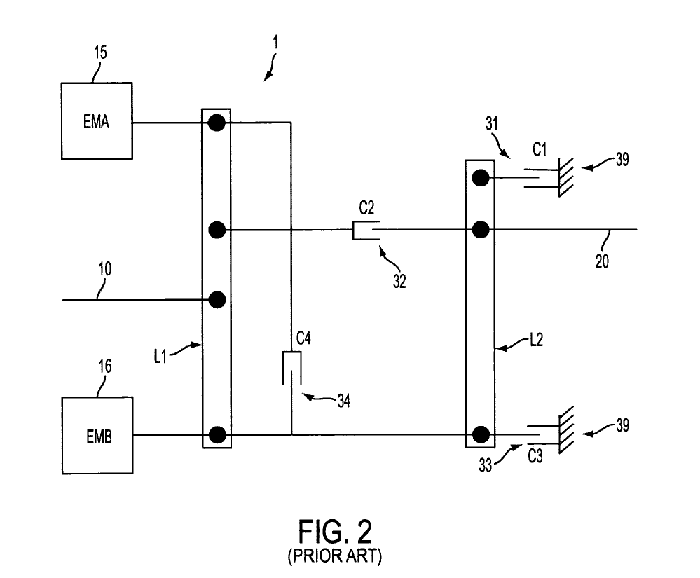

FIG. 2 is an example lever diagram of the hybrid powertrain 1 of FIG. 1. The lever diagram shows exemplary gearing relationships between the components of the hybrid powertrain 1. On lever L1, the gearing relationship between sun gear 51 and EMB 16 (lowermost node), input ring gear 43 and input shaft 10 (second node from the bottom), input carrier 44 (second node from the top), and input sun gear 41 and EMA 15 (uppermost node) is shown. On lever L2, the gearing relationship between output sun gear 61 (lowermost node), output carrier 64 and output shaft 20 (middle node), and output ring gear 63 (uppermost node) is shown.

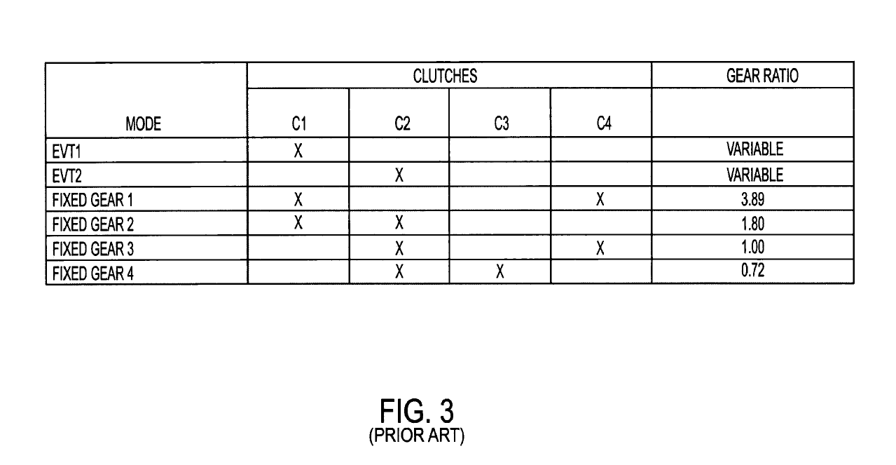

FIG. 3 is a table showing exemplary operating modes of the prior art hybrid powertrain 1 of FIG. 1. The hybrid powertrain of FIG. 1 may be operated as an electric variable ratio transmission (EVT1, EVT2) or as a parallel hybrid powertrain powered by an internal combustion engine (FIXED GEAR 1, FIXED GEAR 2, FIXED GEAR 3, FIXED GEAR 4). The first clutch mechanism 31 (C1), second clutch mechanism 32 (C2), third clutch mechanism 33 (C3), and fourth clutch mechanism 34 (C4) may be selectively activated to achieve the different operating states of the hybrid powertrain 1. An “X” indicates that the clutch has been activated, thereby, coupling together all components to which it is attached. A blank indicates that the clutch has been deactivated, thereby, allowing the components to which it is coupled to rotate independently of one another.

With reference to FIGS. 1 and 3, when the hybrid powertrain 1 is to be operated in a first electric variable ratio mode (EVT1), the first clutch mechanism 31 is activated, and the second, third and fourth clutch mechanisms 32, 33, 34 are deactivated. EMB 16 is powered to provide a torque to shaft 76, thereby causing shaft 77, output sun gear 61 and output pinion gears 62 to rotate. Because the first clutch mechanism 31 is activated, the output ring gear 63 is coupled to the transmission housing 39 through shaft 78 and does not rotate. The non-rotation of the output ring gear 63 forces the output carrier 64 to rotate along with the output pinion gears 62, thereby, rotating the output shaft 20. At the same time, the rotation of shaft 77 forces sun gear 51, pinion gears 52, ring gear 53, carrier 54, shafts 72, 73, 74, 75, input sun gear 41, input pinion gears 42, input carrier 44, and EMA 15 to rotate. To drive with the engine off, EMA 15 must freewheel at speeds proportional to the speed of the vehicle. Thus, at high vehicle speeds, EMA 15 must freewheel at high RPM. High RPM freewheeling of EMA 15 produces disadvantageous system losses within the hybrid powertrain and, accordingly, limits the top speed of the vehicle when operating in a purely electric mode such as EVT1.

To operate the hybrid powertrain 1 in a second electric variable ratio mode (EVT2), the second clutch mechanism 32 is activated, and the first, third and fourth clutch mechanisms 31, 33, 34 are deactivated. EMB 16 is powered to provide a torque to shaft 76, thereby causing shaft 77, sun gear 61, pinion gears 62, carrier 64, sun gear 51, pinion gears 52, ring gear 53, carrier 54, shafts 72, 73, 74, 75, input sun gear 41, pinion gears 42, input carrier 44, and EMA 15 to rotate. Because the second clutch mechanism 32 is activated, shaft 72 is coupled to output carrier 64 and, thereby, output shaft 20. Therefore, input carrier 44, carrier 54, output carrier 64, shaft 72, and output shaft 20 all rotate at the same RPM. Thus, power passes from EMA and EMB 16 to output shaft 20 causing output shaft 20 to rotate. To drive with the engine off in a typical two electric motor hybrid powertrain, EMA 15 and EMB 16 are powered to provide the exact speed necessary such that the input ring gear 43 and, thereby, input shaft 10, coupled to the vehicle's internal combustion engine, do not rotate. This causes both motors to operate at speeds that are not necessarily the most efficient for the power required to propel the vehicle and causes excessive battery power consumption.

To operate the hybrid powertrain 1 as a hybrid powertrain with the internal combustion engine on in a first fixed gear mode (FIXED GEAR 1), the first and fourth clutch mechanisms 31, 34 are activated, and the second and third clutch mechanisms 32, 33 are deactivated. The internal combustion engine rotates input shaft 10, shaft 71 and input ring gear 43. Because the fourth clutch mechanism 34 is applied, the sun gear 51, carrier 54, ring gear 53, shafts 71, 72, 73, 74, 75, 76, 77, input sun gear 41, input carrier 44, input ring gear 43, input shaft 10, and output sun gear 61, all rotate at the same speed. Power is thus transmitted from the engine all the way to the output sun gear 61 and to the output pinion gears 62. Because the first clutch mechanism 31 is activated, the output ring gear 63 is coupled to the transmission housing 39 through shaft 78 and does not rotate. The non-rotation of the output ring gear 63 forces the output carrier 64 to rotate along with the output pinion gears 62, thereby, rotating the output shaft 20 with an exemplary overall transmission gear ratio of 3.89:1. EMA 15 and EMB 16 may assist in providing propulsive force as necessary.

To operate the hybrid powertrain 1 as a hybrid powertrain with the internal combustion engine on in a second fixed gear mode (FIXED GEAR 2), the first and second clutch mechanisms 31, 32 are activated, and the third and fourth clutch mechanisms 33, 34 are deactivated. The internal combustion engine rotates input shaft 10, shaft 71, input ring gear 43, input pinion gears 42, input carrier 44, input sun gear 41, shafts 72, 73, 74, 75, 76, 77, ring gear 53, pinion gears 52, carrier 54, sun gear 51, output sun gear 61, and output pinion gears 62. Because the second clutch mechanism 32 is applied, input carrier 44, carrier 54, shaft 72, output carrier 64, and output shaft 20 all rotate at the same speed. Power is transmitted from the engine all the way to the output ring gear 61 and to the output pinion gears 62. Because the first clutch mechanism 31 is activated, the output ring gear 63 is coupled to the transmission housing 39 through shaft 78 and does not rotate. The non-rotation of the output ring gear 63 forces the output carrier 64 to rotate along with the output pinion gears 62, thereby, rotating the output shaft 20 with an exemplary overall transmission gear ratio of 1.80:1. EMA 15 and EMB 16 may assist in providing propulsive force as necessary.

To operate the hybrid powertrain 1 as a hybrid powertrain with the internal combustion engine on in a third fixed gear mode (FIXED GEAR 3), the second and fourth clutch mechanisms 32, 34 are activated, and the first and third clutch mechanisms 31, 33 are deactivated. The internal combustion engine rotates input shaft 10, shaft 71 and input ring gear 43. Because the fourth clutch mechanism 34 is applied, the sun gear 51, carrier 54, ring gear 53, shafts 72, 73, 74, 75, 76, 77, input sun gear 41, input carrier 44, input ring gear 43, input shaft 10, and output sun gear 61, all rotate at the same speed. Because the second clutch mechanism 32 is applied, input carrier 44, carrier 54, shaft 72, output carrier 64, and output shaft 20 all rotate at the same speed. Power is thus transmitted from the engine to the input sun gear 43 and all the way to the output carrier 64 and output shaft 20 with an exemplary overall transmission gear ratio of 1:1. EMA 15 and EMB 16 may assist in providing propulsive force as necessary.

To operate the hybrid powertrain 1 as a hybrid powertrain with the internal combustion engine on in a fourth fixed gear mode (FIXED GEAR 4), the second and third clutch mechanisms 32, 33 are activated, and the first and fourth clutch mechanisms 31, 34 are deactivated. The internal combustion engine rotates input shaft 10, shaft 71, input ring gear 43, input pinion gears 42, input carrier 41, shafts 72, 73, 74, ring gear 53, pinion gears 52, and carrier 54. Because the third clutch mechanism 33 is applied, sun gear 51, shafts 75, 76, 77, and output sun gear 61 are fixed to the transmission housing 39 and do not rotate. Because the second clutch mechanism 32 is applied, input carrier 44, carrier 54, shaft 72, output carrier 64, and output shaft 20 all rotate at the same speed. Power is transmitted from the engine through shaft 72 and to the output shaft 20 with an exemplary overall transmission gear ratio of 0.72:1. EMA 15 may assist in providing propulsive force as necessary. However, EMB 16 is fixed to the transmission housing 39 by the third clutch mechanism 33.

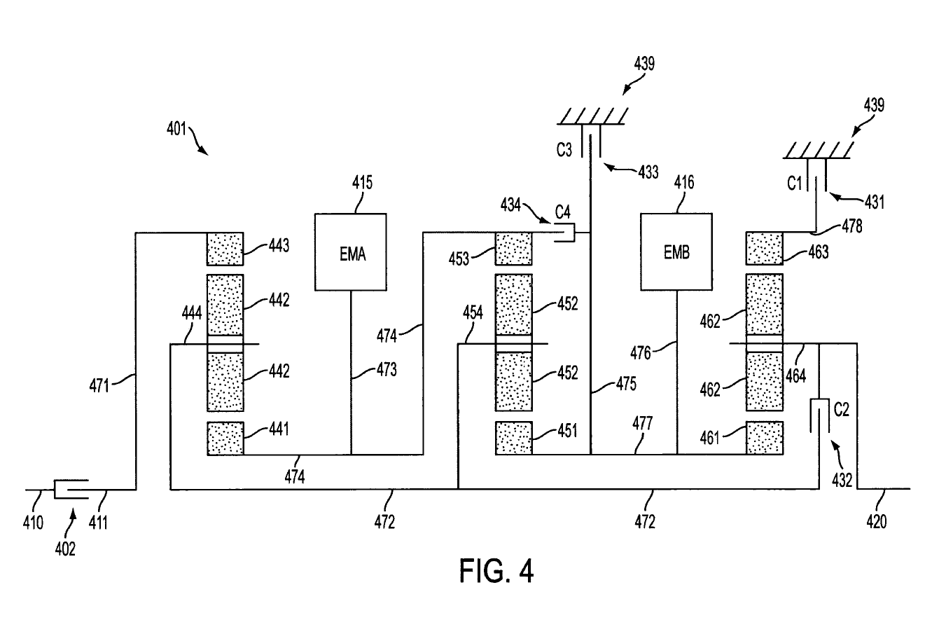

FIG. 4 illustrates an example schematic representation of a hybrid powertrain 401 in accordance with a desired embodiment. The hybrid powertrain 401 includes an input shaft 410 coupled to a disconnect clutch 402. The disconnect clutch 402 permits smoother changes in powertrain operation states and reduces flaring during these changes and startup. In addition, the disconnect clutch 402 enables more efficient use of the electric motors of the powertrain. It also allows EMA 415 and EMB 416 to provide torque to the output shaft in electric mode, increasing the torque to output shaft 420. The disconnect clutch 402 allows one of the electric motors to provide propulsion during powertrain operation without having to power the combustion engine or freewheel the other motor, thus, reduces transmission losses and increases powertrain efficiency.

The disconnect clutch 402 may be any type of clutching device such as a wet or dry clutch. In an example embodiment, the disconnect clutch may be a one-way clutch. A damper may be used in combination with the disconnect clutch 402 as needed. The disconnect clutch 402 selectively couples the input shaft 410 to a transmission input shaft 411. For example, when disconnect clutch 402 is activated, input shaft 410 is coupled to transmission input shaft 411, and when disconnect clutch 402 is deactivated, input shaft 410 is not coupled to transmission input shaft 411. The transmission input shaft 411 is coupled to an input ring gear 443 by a shaft 471. The input ring gear 443 is continuously meshed with a plurality of input pinion gears 442 that are in turn meshed with an input sun gear 441. The input sun gear 441 is coupled by a shaft 474 to a ring gear 453. The shaft 474 is coupled by another shaft 473 to a first electric motor 415 (“EMA”). An input carrier 444, upon which the input pinion gears 442 are rotatably mounted, is coupled to a shaft 472.

The ring gear 453 is continuously meshed with a plurality of pinion gears 452 that are in turn meshed with a sun gear 451. The sun gear 451 is coupled by a shaft 477 to an output sun gear 461. The powertrain 401 includes four additional clutch mechanisms 431 (C1), 432 (C2), 433 (C3), 434 (C4). A shaft 475 couples shaft 477 to the third clutch mechanism 433. The third clutch mechanism 433 selectively couples shaft 475 and, thereby, shaft 477 to the transmission housing 439. A shaft 476 couples shaft 477 to a second electric motor 416 (“EMB”). The ring gear 453 and, thereby, shaft 474, is selectively coupled to shaft 475 by the fourth clutch mechanism 434. A carrier 454, upon which pinion gears 452 are rotatably mounted, is coupled to a shaft 472.

The output sun gear 461 is continuously meshed with a plurality of output pinion gears 462 that are in turn meshed with an output ring gear 463. The output ring gear 463 is coupled by a shaft 478 to the first clutch mechanism 431. The first clutch mechanism 431 selectively couples shaft 478 and, thereby, output ring gear 463 to the transmission housing 439. An output carrier 464, upon which output pinion gears 462 are rotatably mounted, is coupled to an output shaft 420. The output carrier 464 is also coupled to the second clutch mechanism 432. The shaft 472 and, thereby, input carrier 444 and carrier 454 are coupled to the second clutch mechanism 432. The second clutch mechanism 432 selectively couples shaft 472 to output carrier 464.

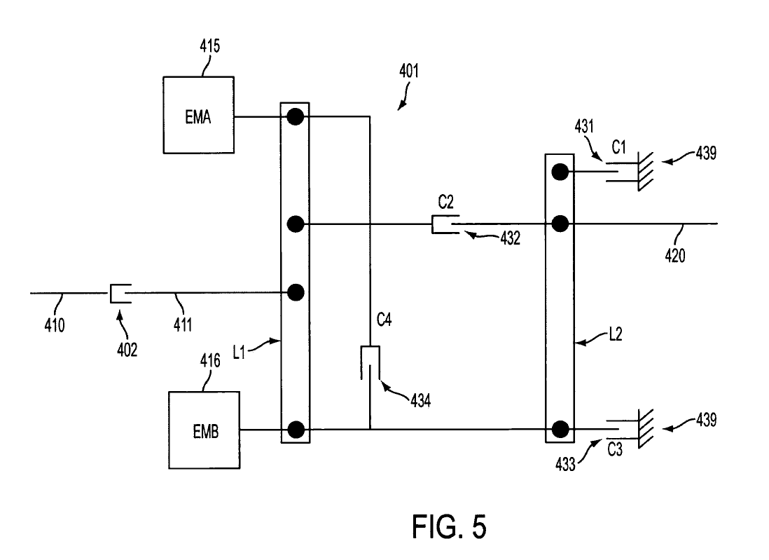

FIG. 5 is an example lever diagram of the hybrid powertrain 401 of FIG. 4. The lever diagram shows exemplary gearing relationships between the components of the hybrid powertrain 401. On lever L1, the gearing relationship between sun gear 451 and EMB 416 (lowermost node), input ring gear 443 and input shaft 410 (second node from the bottom), input carrier 444 (second node from the top), and input sun gear 441 and EMA 415 (uppermost node) is shown. On lever L2, the gearing relationship between output sun gear 461 (lowermost node), output carrier 464 and output shaft 420 (middle node), and output ring gear 463 (uppermost node) is shown.

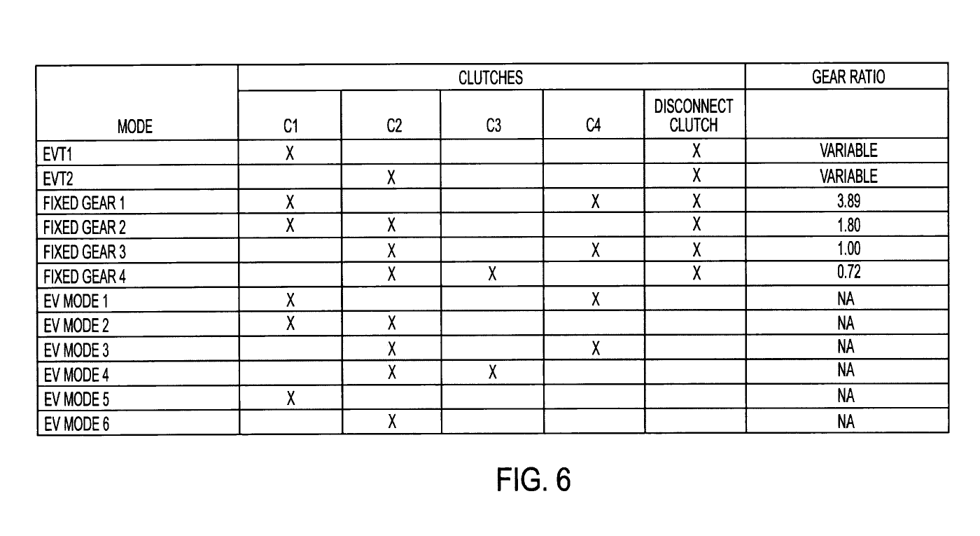

FIG. 6 is a table showing example operating modes of the hybrid powertrain 401 of FIG. 4. The hybrid powertrain 401 of FIG. 4 may be operated as a electric transmission (EVT1, EVT2), as a hybrid powertrain with the assistance of an internal combustion engine (FIXED GEAR 1, FIXED GEAR 2, FIXED GEAR 3, FIXED GEAR 4), or as a purely electric transmission in which the internal combustion engine is disconnected from the transmission (EV MODE 1, EV MODE 2, EV MODE 3, EV MODE 4, EV MODE 5, EV MODE 6). The first clutch mechanism 431 (C1), second clutch mechanism 432 (C2), third clutch mechanism 433 (C3), fourth clutch mechanism 434 (C4), and disconnect clutch 402 may be selectively activated to achieve the different operating states of the hybrid powertrain 401. An “X” indicates that the clutch has been activated, thereby, coupling together all components to which it is attached. A blank indicates that the clutch has been deactivated, thereby, allowing the components to which it is coupled to rotate independently of one another.

With reference to FIGS. 4 and 6, when the hybrid powertrain 401 is to be operated in a first electric variable ratio mode (EVT1), the first clutch mechanism 431 and the disconnect clutch 402 are activated, and the second, third and fourth clutch mechanisms 432, 433, 434 are deactivated. Because the disconnect clutch 402 is activated, the input shaft 410 and transmission input shaft 411 are coupled together. EMB 416 is powered to provide a torque to shaft 476, thereby causing shaft 477, output sun gear 461 and output pinion gears 462 to rotate. Because the first clutch mechanism 431 is activated, the output ring gear 463 is coupled to the transmission housing 439 through shaft 478 and does not rotate. The non-rotation of the output ring gear 463 forces the output carrier 464 to rotate along with the output pinion gears 462, thereby, rotating the output shaft 420. At the same time, the rotation of shaft 477 forces sun gear 451, pinion gears 452, ring gear 453, carrier 454, shafts 472, 473, 474, 475, input sun gear 441, input pinion gears 442, input carrier 444, and EMA 415 to rotate. To drive with the engine off, EMA 415 is powered to freewheel at the exact speed necessary such that the input ring gear 443 and, thereby, input shaft 410, coupled to the vehicle's internal combustion engine, do not rotate.

To operate the hybrid powertrain 401 in a second electric variable ratio mode (EVT2), the second clutch mechanism 432 and the disconnect clutch 402 are activated, and the first, third and fourth clutch mechanisms 431, 433, 434 are deactivated. Because the disconnect clutch 402 is activated, the input shaft 410 and transmission input shaft 411 are coupled together. EMB 416 is powered to provide a torque to shaft 476, thereby causing shaft 477, sun gear 461, pinion gears 462, carrier 464, sun gear 451, pinion gears 452, ring gear 453, carrier 454, shafts 472, 473, 474, 475, input sun gear 441, pinion gears 442, input carrier 444, and EMA 415 to rotate. Because the second clutch mechanism 432 is activated, shaft 472 is coupled to output carrier 464 and, thereby, output shaft 420. Therefore, input carrier 444, carrier 454, output carrier 464, shaft 472, and output shaft 420 all rotate at the same RPM. Thus, power passes from EMB 416 to output shaft 420 causing output shaft 420 to rotate. To drive with the engine off in a typical two electric motor hybrid powertrain, EMA 415 and EMB 416 are powered to provide the exact speed necessary such that the input ring gear 443 and, thereby, input shaft 410, coupled to the vehicle's internal combustion engine, do not rotate. This causes both motors to operate at speeds that are not necessarily the most efficient for the power required to propel the vehicle and causes excessive battery power consumption.

To operate the hybrid powertrain 401 as a hybrid powertrain with the internal combustion engine on in a first fixed gear mode (FIXED GEAR 1), the first and fourth clutch mechanisms 431, 434 and the disconnect clutch 402 are activated, and the second and third clutch mechanisms 432, 433 are deactivated. Because the disconnect clutch 402 is activated, the input shaft 410 and transmission input shaft 411 are coupled together. The internal combustion engine rotates input shaft 410, transmission input shaft 411, shaft 471 and input ring gear 443. Because the fourth clutch Mechanism 434 is applied, the sun gear 451, carrier 454, ring gear 453, shafts 471, 472, 473, 474, 475, 476, 477, input sun gear 441, input carrier 444, input ring gear 443, transmission input shaft 411, input shaft 410, and output sun gear 461, all rotate at the same speed. Power is thus transmitted from the engine all the way to the output sun gear 461 and to the output pinion gears 462. Because the first clutch mechanism 431 is activated, the output ring gear 463 is coupled to the transmission housing 439 through shaft 478 and does not rotate. The non-rotation of the output ring gear 463 forces the output carrier 464 to rotate along with the output pinion gears 462, thereby, rotating the output shaft 420 with an exemplary overall transmission gear ratio of 3.89:1. EMA 415 and EMB 416 may assist in providing propulsive force as necessary.

To operate the hybrid powertrain 401 as a hybrid powertrain with the internal combustion engine on in a second fixed gear mode (FIXED GEAR 2), the first and second clutch mechanisms 431, 432 and the disconnect clutch 402 are activated, and the third and fourth clutch mechanisms 433, 434 are deactivated. Because the disconnect clutch 402 is activated, the input shaft 410 and transmission input shaft 411 are coupled together. The internal combustion engine rotates input shaft 410, transmission input shaft 411, shaft 471, input ring gear 443, input pinion gears 442, input carrier 444, input sun gear 441, shafts 472, 473, 474, 475, 476, 477, ring gear 453, pinion gears 452, carrier 454, sun gear 451, output sun gear 461, and output pinion gears 462. Because the second clutch mechanism 432 is applied, input carrier 444, carrier 454, shaft 442, output carrier 464, and output shaft 420 all rotate at the same speed. Power is transmitted from the engine all the way to the output ring gear 461 and to the output pinion gears 462. Because the first clutch mechanism 431 is activated, the output ring gear 463 is coupled to the transmission housing 439 through shaft 478 and does not rotate. The non-rotation of the output ring gear 463 forces the output carrier 464 to rotate along with the output pinion gears 462, thereby, rotating the output shaft 420 with an exemplary overall transmission gear ratio of 1.80:1. EMA 415 and EMB 416 may assist in providing propulsive force as necessary.

To operate the hybrid powertrain 401 as a hybrid powertrain with the internal combustion engine on in a third fixed gear mode (FIXED GEAR 3), the second and fourth clutch mechanisms 432, 434 and the disconnect clutch 402 are activated, and the first and third clutch mechanisms 431, 433 are deactivated. Because the disconnect clutch 402 is activated, the input shaft 410 and transmission input shaft 411 are coupled together. The internal combustion engine rotates input shaft 410, transmission input shaft 411, shaft 471 and input ring gear 443. Because the fourth clutch mechanism 434 is applied, the sun gear 451, carrier 454, ring gear 453, shafts 471, 472, 473, 474, 475, 476, 477, input sun gear 441, input carrier 444, input ring gear 443, input pinion gears 442, transmission input shaft 411, input shaft 410, and output sun gear 461, all rotate at the same speed. Because the second clutch mechanism 432 is applied, input carrier 444, carrier 454, shaft 472, output carrier 464, and output shaft 420 all rotate at the same speed. Power is thus transmitted from the engine to the input sun gear 443 and all the way to the output carrier 464 and output shaft 420 with an exemplary overall transmission gear ratio of 1:1. EMA 415 and EMB 416 may assist in providing propulsive force as necessary.

To operate the hybrid powertrain 401 as a hybrid powertrain with the internal combustion engine on in a fourth fixed gear mode (FIXED GEAR 4), the second and third clutch mechanisms 432, 433 and the disconnect clutch 402 are activated, and the first and fourth clutch mechanisms 431, 434 are deactivated. Because the disconnect clutch 402 is activated, the input shaft 410 and transmission input shaft 411 are coupled together. The internal combustion engine rotates input shaft 410, transmission input shaft 411, shaft 471, input ring gear 443, input pinion gears 442, input carrier 441, shafts 472, 473, 474, ring gear 453, pinion gears 452, and carrier 454. Because the third clutch mechanism 433 is applied, sun gear 451, shafts 475, 476, 477, and output sun gear 461 are fixed to the transmission housing 439 and do not rotate. Likewise, because the second clutch mechanism 432 is applied, input carrier 444, carrier 454, shaft 472, output carrier 464, and output shaft 420 all rotate at the same speed. Power is transmitted from the engine through shaft 472 and to the output shaft 420 with an exemplary overall transmission gear ratio of 0.72:1. EMA 415 may assist in providing propulsive force as necessary. However, EMB 416 is fixed to the transmission housing 439 by the third clutch mechanism 433.

To operate the hybrid powertrain 401 in a first purely electric mode with the internal combustion engine disconnected (EV MODE 1), the first and fourth clutch mechanisms 431, 434 are activated, and the second and third clutch mechanisms 432, 433 and the disconnect clutch 402 are deactivated. Thus, the transmission input shaft 411 is free to rotate independently of the input shaft 410 and the internal combustion engine. Because the fourth clutch mechanism 434 is applied, sun gear 451, carrier 454, ring gear 453, shafts 471, 472, 473, 474, 475, 476, 477, input sun gear 441, input carrier 444, input ring gear 443, transmission input shaft 411, and output sun gear 461, all rotate at the same speed. Thus, any torque applied to shaft 473 by EMA 415 or shaft 476 by EMB 416 causes sun gear 451, pinion gears 452, carrier 454, ring gear 453, shafts 471, 472, 473, 474, 475, 476, 477, input sun gear 441, input carrier 444, input ring gear 443, transmission input shaft 411, and output sun gear 461 to rotate. Rotation of the output sun gear 461 causes the output pinion gears 462 to rotate. Because the first clutch mechanism 431 is activated, the output ring gear 463 is coupled to the transmission housing 439 through shaft 478 and does not rotate. The non-rotation of the output ring gear 463 forces the output carrier 464 to rotate along with the output pinion gears 462, thereby, rotating the output shaft 420. Thus, the torque applied by EMA 415 and EMB 416 causes the output shaft 420 to rotate.

To operate the hybrid powertrain 401 in a second purely electric mode with the internal combustion engine disconnected (EV MODE 2), the first and second clutch mechanisms 431, 432 are activated, and the third and fourth clutch mechanisms 433, 434 and the disconnect clutch 402 are deactivated. Thus, the transmission input shaft 411 is free to rotate independently of the input shaft 410 and the internal combustion engine. Because the second clutch mechanism 432 is applied, input carrier 444, carrier 454, shaft 472, output carrier 464, and output shaft 420 all rotate at the same speed. Torque applied to shaft 473 by EMA 415 or shaft 476 by EMB 416 causes shafts 472, 474, 475, 477, sun gear 451, pinion gears 452, ring gear 453, input sun gear 441, input pinion gears 442, output sun gear 461, input carrier 444, carrier 454, shaft 472, and output carrier 464 to rotate. Because the first clutch mechanism 431 is activated, the output ring gear 463 is coupled to the transmission housing 439 through shaft 478 and does not rotate. The non-rotation of the output ring gear 463 forces the output carrier 464 to rotate along with the output pinion gears 462, thereby, rotating the output shaft 420. Thus, the torque applied by EMA 415 and EMB 416 causes the output shaft 420 to rotate.

To operate the hybrid powertrain 401 in a third purely electric mode with the internal combustion engine disconnected (EV MODE 3), the second and fourth clutch mechanisms 432, 434 are activated, and the first and third clutch mechanisms 431, 433 and the disconnect clutch 402 are deactivated. Thus, the transmission input shaft 411 is free to rotate independently of the input shaft 410 and the internal combustion engine. Because the fourth clutch mechanism 434 is applied, sun gear 451, carrier 454, ring gear 453, shafts 472, 473, 474, 475, 476, 477, input sun gear 441, input carrier 444, input ring gear 443, and output sun gear 461, all rotate at the same speed. Torque applied to shaft 473 by EMA 415 or shaft 476 by EMB 416 causes sun gear 451, carrier 454, ring gear 453, shafts 472, 473, 474, 475, 476, 477, input sun gear 441, input carrier 444, input ring gear 443, and output sun gear 461 to rotate. Because the second clutch mechanism 432 is applied, input carrier 444, carrier 454, shaft 472, output carrier 464, and output shaft 420 all rotate at the same speed. Thus, the torque applied by EMA 415 and EMB 416 causes the output shaft 420 to rotate.

To operate the hybrid powertrain 401 in a fourth purely electric mode with the internal combustion engine disconnected (EV MODE 4), the second and third clutch mechanisms 432, 433 are activated, and the first and fourth clutch mechanisms 431, 434 and the disconnect clutch 402 are deactivated. Thus, the transmission input shaft 411 is free to rotate independently of the input shaft 410 and the internal combustion engine. Because the third clutch mechanism 433 is applied, sun gear 451, shafts 475, 476, 477 and output sun gear 461 are fixed to the transmission housing 439 and do not rotate. Thus, EMB 416 is unable to provide torque for propulsion. Because the second clutch mechanism 432 is applied, input carrier 444, carrier 454, shaft 472, output carrier 464, and output shaft 420 all rotate at the same speed. Torque applied to shaft 473 by EMA 415 causes shafts 472, 474, 478, input sun gear 441, input pinion gears 442, input carrier 444, ring gear 453, pinion gears 452, carrier 454, output carrier 464, pinion gears 462, ring gear 463 to rotate. Thus, the torque applied by EMA 415 causes the output shaft 420 to rotate.

To operate the hybrid powertrain 401 in a fifth purely electric mode with the internal combustion engine disconnected (EV MODE 5), the first clutch mechanism 431 is activated, and the second, third and fourth clutch mechanisms 432, 433, 434 and the disconnect clutch 402 are deactivated. Thus, the transmission input shaft 411 is free to rotate independently of the input shaft 410 and the internal combustion engine. Because the first clutch mechanism 431 is applied, ring gear 463 is fixed to the transmission housing 439 and does not rotate. Torque applied to shaft 476 by EMB 416 causes shaft 477, sun gear 461, pinion gears 462, and output carrier 464 to rotate. Thus, the torque applied by EMB 416 causes output shaft 420 to rotate. At the same time, EMA 415 may be stopped and need not be powered. Alternatively, EMA 415 may be powered to synchronize the rotation of the transmission input shaft 411 and input shaft 410 for an engine start.

To operate the hybrid powertrain 401 in a sixth purely electric mode with the internal combustion engine disconnected (EV MODE 6), the second clutch mechanism 432 is activated, and the first, third and fourth clutch mechanisms 431, 433, 434 and the disconnect clutch 402 are deactivated. Thus, the transmission input shaft 411 is free to rotate independently of the input shaft 410 and the internal combustion engine. EMA 415 is powered to provide a torque to shaft 473 and EMB 416 is powered to provide a torque to shaft 476, thereby causing shaft 477, sun gear 461, pinion gears 462, carrier 464, sun gear 451, pinion gears 452, ring gear 453, carrier 454, shafts 472, 473, 474, 475, input sun gear 441, pinion gears 442, input carrier 444, and EMA 415 to rotate. Because the second clutch mechanism 432 is activated, shaft 472 is coupled to output carrier 464 and, thereby, output shaft 420. Therefore, input carrier 444, carrier 454, output carrier 464, shaft 472, and output shaft 420 all rotate at the same RPM. Thus, power passes from EMA 415 and EMB 416 to output shaft 420 causing output shaft 420 to rotate.

One exemplary prior art hybrid powertrain has no internal clutches. Propulsive power in the exemplary hybrid powertrain is provided by the internal combustion engine and electric motors (EMA, EMB). The internal combustion engine cannot be disconnected from the hybrid powertrain and the engine or both motors must always rotate when the vehicle is in motion.

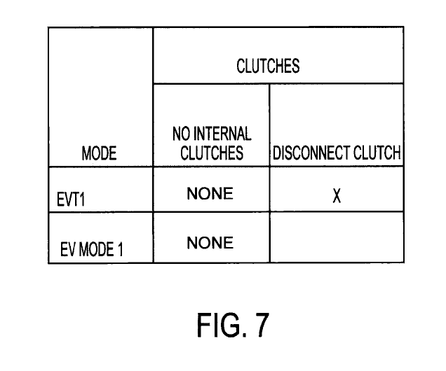

FIG. 7 is a table showing operating modes of the hybrid powertrain having no internal clutches and fitted with a disconnect clutch. The hybrid powertrain may be operated in an electric variable ratio mode (EVT1) or in a purely electric mode (EV Mode 1) with the internal combustion engine disconnected. The disconnect clutch is activated to operate the hybrid powertrain in EVT1. Because the disconnect clutch is activated, the input shaft and transmission input shaft are coupled together and both the internal combustion engine and electric motors (EMA, EMB) within the hybrid powertrain can provide propulsion. To operate the hybrid powertrain in EV Mode 1, the disconnect clutch is deactivated. Thus, the transmission input shaft is free to rotate independently of the input shaft and the internal combustion engine. One of the electric motors EMA, EMB may provide propulsive power and the other motor need not rotate. Alternatively, the second electric motor may be powered to synchronize the rotation of the transmission input shaft and input shaft for an engine start.

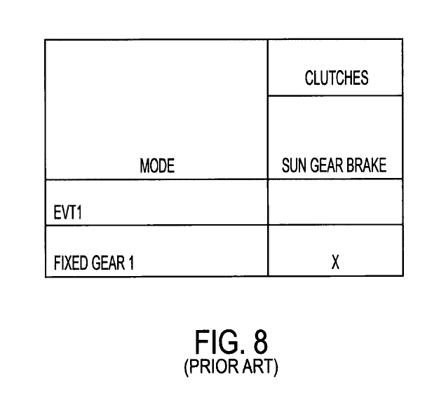

FIG. 8 is a table showing operating modes of another prior art powertrain. The exemplary hybrid powertrain has a brake on a sun gear within the hybrid powertrain. The brake mechanism selectively couples the sun gear to the housing of the hybrid powertrain, thereby, preventing the sun gear from rotating. Propulsive power in the hybrid powertrain of FIG. 8 is provided by the internal combustion engine and electric motors (EMA, EMB). The internal combustion engine cannot be disconnected from the hybrid powertrain and the engine or both motors must always rotate when the vehicle is in motion. The hybrid powertrain may be operated as an electrically variable transmission (EVT1) by deactivating the brake on the sun gear, or as a fixed gear transmission (Fixed Gear 1) by activating the brake on the sun gear.

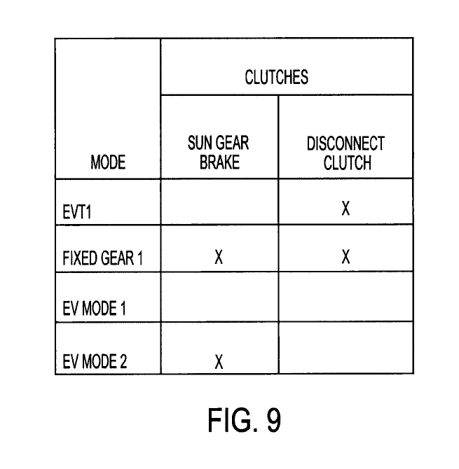

FIG. 9 is a table showing operating modes of the hybrid powertrain of FIG. 8 fitted with a disconnect clutch. The hybrid powertrain may be operated in an electric variable ratio mode (EVT1), a fixed gear mode (Fixed Gear 1) or in purely electric modes (EV Mode 1, 2) with the internal combustion engine disconnected. To operate the hybrid powertrain in EVT1, the sun gear brake is deactivated and the disconnect clutch is activated. Because the disconnect clutch is activated, the input shaft and transmission input shaft are coupled together and both the internal combustion engine and electric motors (EMA, EMB) within the hybrid powertrain can provide propulsion. To operate the hybrid powertrain in Fixed Gear 1, the sun gear brake and disconnect clutch are activated. Thus, the internal combustion engine and one of the electric motors (EMA, EMB) within the hybrid powertrain can provide propulsion. To operate the hybrid powertrain in EV Mode 1, the sun gear brake and disconnect clutch are deactivated. Thus, one of the electric motors (EMA, EMB) within the hybrid powertrain can provide propulsion. In addition, the second electric motor may be powered to synchronize the rotation of the transmission input shaft and input shaft for an engine start. To operate the hybrid powertrain in EV Mode 2, the sun gear brake is activated and the disconnect clutch is deactivated. Thus, one of the electric motors (EMA, EMB) within the hybrid powertrain can provide propulsion.

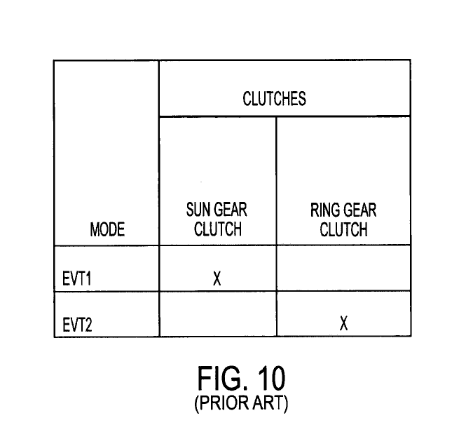

FIG. 10 is a table showing operating modes of another prior art powertrain. The exemplary hybrid powertrain has a sun gear clutch and a ring gear clutch within the hybrid powertrain. Propulsive power in the hybrid powertrain of FIG. 10 is provided by the internal combustion engine and electric motors (EMA, EMB). The internal combustion engine cannot be disconnected from the hybrid powertrain and the engine or both motors must always rotate when the vehicle is in motion. The hybrid powertrain is operated exclusively as a purely electric variable ratio transmission (EVT1, 2). To operate the hybrid powertrain in EVT1, the sun gear clutch is activated and the ring gear clutch is deactivated. To operate the hybrid powertrain in EVT2, the ring gear clutch is activated and the sun gear clutch is deactivated.

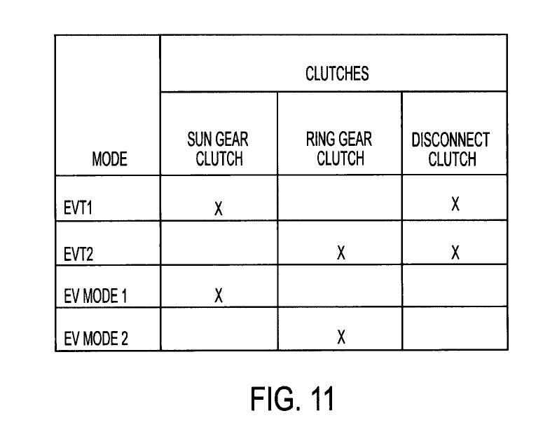

FIG. 11 is a table showing operating modes of the hybrid powertrain of FIG. 10 fitted with a disconnect clutch. The hybrid powertrain may be operated in purely electric variable ratio modes (EVT1, 2) or in purely electric modes (EV Mode 1, 2) with the internal combustion engine disconnected. To operate the hybrid powertrain in EVT1 in which propulsive power is provided by the internal combustion engine and electric motors (EMA, EMB), the sun gear clutch and disconnect clutch are activated and the ring gear clutch is deactivated. To operate the hybrid powertrain in EVT2 in which propulsive power is provided by the internal combustion engine and electric motors (EMA, EMB), the ring gear clutch and disconnect clutch are activated and the sun gear clutch is deactivated. To operate the hybrid powertrain in EV Mode 1, the sun gear clutch is activated and the ring gear clutch and disconnect clutch are deactivated. Thus, one of the electric motors (EMA, EMB) within the hybrid powertrain can provide propulsion. In addition, the second electric motor may be powered to synchronize the rotation of the transmission input shaft and input shaft for an engine start. To operate the hybrid powertrain in EV Mode 2, the ring gear clutch is activated and the sun gear clutch and disconnect clutch are deactivated. Thus, one of the electric motors (EMA, EMB) within the hybrid powertrain can provide propulsion. In addition, the second electric motor may be powered to synchronize the rotation of the transmission input shaft and input shaft for an engine start.

In EV MODE operation, the disconnect clutch of the disclosed hybrid powertrain is deactivated, thereby, disconnecting and allowing free rotation between the internal combustion engine coupled to the input shaft and the transmission input shaft. Because the transmission input shaft must no longer be maintained at 0 RPM, EMA need not be freewheeled during electric vehicle operation, thus, reduces transmission losses and increases the efficiency of the hybrid powertrain. It should be noted that the input shaft may be any shaft that transmits power from an internal combustion engine or other power source to the hybrid transmission, including the internal combustion engine crankshaft.

In many exemplary embodiments, the disconnect clutch may also be used to start the vehicle's internal combustion engine even when the vehicle is travelling at high rates of speed under purely electric propulsion. For instance, the disconnect clutch may be slipped during the starting procedure, thereby minimizing any jolting or passenger discomfort that might otherwise be caused during the engine start procedure. Alternatively, the disconnect clutch may be engaged once EMA and EMB have synchronized the input shaft and transmission input shaft speeds. The use of the disconnect clutch also prevents a large overshoot of internal combustion engine RPM (flare) during the starting procedure.

What is claimed is:

1. A hybrid powertrain comprising:
an input shaft;
a disconnect clutch coupled to said input shaft;
a transmission input shaft coupled to said disconnect clutch;
a first plurality of gears and shafts coupled to said transmission input shaft;
a first electric motor coupled to said first plurality of gears and shafts;
a second electric motor coupled to said first plurality of gears and shafts; and
an output shaft coupled to said first plurality of gears and shafts.

2. The hybrid powertrain of claim 1, wherein said first plurality of gears and shafts comprises a planetary gear set, wherein:
a carrier of said planetary gear set is coupled to said transmission input shaft,
a sun gear of said planetary gear set is coupled to said first electric motor, and
a ring gear of said planetary gear set is coupled to said second electric motor and said output shaft.

3. The hybrid powertrain of claim 2, wherein said second electric motor is coupled directly to said output shaft.

4. The hybrid powertrain of claim 2, wherein:
said second electric motor is coupled to a second plurality of gears and shafts; and
said output shaft is coupled to said second plurality of gears and shafts.

5. The hybrid powertrain of claim 1, further comprising:
a brake mechanism, wherein said first plurality of gears and shafts comprises a planetary gear set, wherein:
a carrier of said planetary gear set is coupled to said transmission input shaft,
a sun gear of said planetary gear set is coupled to said first electric motor and said brake mechanism,
a ring gear of said planetary gear set is coupled to said second electric motor and said output shaft, and
said brake mechanism is coupled to the housing of said hybrid powertrain.

6. The hybrid powertrain of claim 5, wherein said ring gear is coupled to said second electric motor and said output shaft by a second plurality of gears.

7. The hybrid powertrain of claim 6, wherein said disconnect clutch is a one-way clutch.

8. The hybrid powertrain of claim 1, further comprising:
a first brake mechanism;
a second brake mechanism; and
a second plurality of gears and shafts, wherein
said first plurality of gears and shafts comprises a first planetary gear set, wherein:
a carrier of said first planetary gear set is coupled to said transmission input shaft,
a sun gear of said first planetary gear set is coupled to said first electric motor, and
a ring gear of said first planetary gear set is coupled to said output shaft; and
said second plurality of gears and shafts comprises a Ravigneaux planetary gear set, wherein:
a Ravigneaux carrier of said Ravigneaux planetary gear set is coupled to said ring gear of said first planetary gear set,
a Ravigneaux first sun gear of said Ravigneaux planetary gear set is coupled to said second electric motor,
said Ravigneaux first sun gear of said Ravigneaux planetary gear set is meshed with a Ravigneaux first planet gear,
a Ravigneaux second sun gear of said Ravigneaux planetary gear set is coupled to said first brake mechanism,
a Ravigneaux second planet gear is meshed with said Ravigneaux second sun gear and said Ravigneaux first planet gear, and
a Ravigneaux ring gear is coupled to said second brake mechanism and meshed with said Ravigneaux first planet gear.

9. The hybrid powertrain of claim 8, wherein said ring gear of said first planetary gear set is coupled directly to said output shaft.

10. The hybrid powertrain of claim 8, wherein said ring gear of said first planetary gear set is coupled to said output shaft by a third plurality of gears and shafts.

11. The hybrid powertrain of claim 1, further comprising:
an input planetary gear set coupled to said transmission input shaft;
a planetary gear set coupled to said input planetary gear set; and
an output planetary gear set coupled to said input planetary gear set and said planetary gear set.

12. The hybrid powertrain of claim 11, wherein:
said input planetary gear set further comprises:
an input ring gear coupled to said transmission input shaft,
a plurality of input pinion gears continuously meshed with said input ring gear,
an input sun gear continuously meshed with said plurality of input pinion gears, and
an input carrier rotatably coupled to said input pinion gears;
said planetary gear set further comprises:
a ring gear coupled to said input sun gear,
a plurality of pinion gears continuously meshed with said ring gear,
a sun gear continuously meshed with said plurality of pinion gears, and
a carrier rotatably coupled to said pinion gears and coupled to said input carrier; and
said output planetary gear set further comprises:
an output ring gear,
a plurality of output pinion gears continuously meshed with said output ring gear,
an output sun gear continuously meshed with said plurality of output pinion gears and coupled to said sun gear, and
an output carrier rotatably coupled to said output pinion gears and coupled to said output shaft,
wherein said first electric motor is coupled to said input sun gear and said ring gear, and said second electric motor is coupled to said sun gear and said output sun gear.

13. The hybrid powertrain of claim 12, wherein:
said ring gear is selectively coupled to said sun gear;
said sun gear, said second electric motor, and said output sun gear are selectively coupled to a transmission housing;
said output ring gear is selectively coupled to said transmission housing; and
said input carrier and carrier are selectively coupled to said output carrier and said output shaft.

14. The hybrid powertrain of claim 13, wherein said disconnect clutch is a wet clutch or a dry clutch.

15. A powertrain comprising:
an input shaft;
a disconnect clutch coupled to said input shaft;
a transmission input shaft coupled to said disconnect clutch;
an output shaft coupled to said transmission input shaft through at least a first gear set;
a first electric motor coupled to said first gear set; and
a second electric motor coupled to said first gear set.

16. The powertrain of claim 15, wherein said first gear set comprises a planetary gear set, wherein:
a carrier of said planetary gear set is coupled to said transmission input shaft,
a sun gear of said planetary gear set is coupled to said first electric motor, and
a ring gear of said planetary gear set is coupled to said second electric motor and said output shaft.

17. The powertrain of claim 16, wherein said second electric motor is coupled directly to said output shaft.

18. The powertrain of claim 16, wherein said second electric motor is coupled to said output shaft through a second gear set.

19. The powertrain of claim 15, further comprising:
a brake mechanism, wherein
said first gear set comprises a planetary gear set, wherein:
a carrier of said planetary gear set is coupled to said transmission input shaft,
a sun gear of said planetary gear set is coupled to said first electric motor and said brake,
a ring gear of said planetary gear set is coupled to said second electric motor and said output shaft, and
said brake mechanism is coupled to the housing of said powertrain.

20. The powertrain of claim 15, further comprising:
a first brake mechanism;
a second brake mechanism; and
a second gear set, wherein
said first gear set comprises a first planetary gear set, wherein:
a carrier of said first planetary gear set is coupled to said transmission input shaft,
a sun gear of said first planetary gear set is coupled to said first electric motor, and
a ring gear of said first planetary gear set is coupled to said output shaft;
said second gear set comprises a Ravigneaux planetary gear set, wherein:
a Ravigneaux carrier of said Ravigneaux planetary gear set is coupled to said ring gear of said first planetary gear set,
a Ravigneaux first sun gear of said Ravigneaux planetary gear set is coupled to said second electric motor,
said Ravigneaux first sun gear of said Ravigneaux planetary gear set is meshed with a Ravigneaux first planet gear,
a Ravigneaux second sun gear of said Ravigneaux planetary gear set is coupled to said first brake mechanism,
a Ravigneaux second planet gear is meshed with said Ravigneaux second sun gear and said Ravigneaux first planet gear, and
a Ravigneaux ring gear is coupled to said second brake mechanism and meshed with said Ravigneaux first planet gear.
